(19) United States
(12) Patent Application Publication
(10) Pub. No.: US 2006/0165482 A1
(43) Pub. Date: Jul. 27, 2006

(54) Novel enhanced apparatus and method connecting structural members

(76) Inventor: David John Olberding, Charlotte, NC (US)

Correspondence Address: GREENBERG TRAURIG LLP, 2450 COLORADO AVENUE, SUITE 400E, SANTA MONICA, CA, 90404, US

(21) Appl. No.: 11/303,386

(22) Filed: Dec. 16, 2005

Related U.S. Application Data
(60) Provisional application No. 60/643,791, filed on Jan. 11, 2005.

(51) Int. Cl. B23Q 1/48

(52) U.S. Cl. 403/381

(57) ABSTRACT

Disclosed is a novel enhanced structural connector and method of using the structural connector. The device comprises a male member that may engage and interconnect with a female member. Male member comprises a male protuberance that is received by a female notch. Male protuberance and female notch resemble and operate similarly to dovetail connectors common in the art and carry load on the inward surfaces when interconnected. Also disclosed is a novel cup-like member comprising multiple female members that serves as a node for interconnection of a plurality of structural components.

### CROSS-REFERENCE

This application is a utility application and claims the benefit of the prior filing date of U.S. provisional patent application No. 60/643,791 filed on Jan. 11, 2005 entitled “Post to Beam Connector” by David J. Olberding, the disclosures of which are incorporated herein by reference in their entirety.

### BACKGROUND

The present disclosure relates to devices and methods for construction enterprises and support structures. In particular, the present disclosure relates to connectors for use with structural members in buildings and other implements requiring a structural framework. In the aftermath of recent hurricane activity, the present disclosure is well adapted for use as a connector in structures such as temporary, semi-permanent, and permanent shelters for those displaced as a result of these natural phenomena and to speed erection of permanent infrastructure to facilitate speed of recovery.

Attempts to address these problems can be found in the following references: U.S. Pat. Nos. 5,244,300; 5,487,479; 5,860,759; 6,193,436; 6,354,759; 6,357,959; and 6,474,901, each of which is incorporated by reference as if fully disclosed herein. However, all of the following references suffer from one or more of the following disadvantages: they require bolts, pins, nails, welds, or other means of ensuring pieces of the connector remain fixed relative to each other, they carry force in alternative locations from that of the present disclosure, or they are not self-aligning.

### SUMMARY

Disclosed is a novel enhanced structural connector and method of using the structural connector. The device comprises a male member that may engage and interconnect with a female member. Male member comprises a male protuberance that is received by a female notch. Male protuberance and female notch resemble and operate similarly to dovetail connectors common in the art and carry load on the inward surfaces when interconnected. Also disclosed is a novel cup-like member comprising multiple female members that serves as a node for interconnection of a plurality of structural components.

Specifically, the present disclosure relates to an apparatus for connecting structural members together comprising, in combination a male member and a female member, wherein interconnection of the male member and the female member carries load, and wherein load is carried by the articulation of at least one male side face and at least one female side face and the articulation of an inward male face and an inward female face.

More specifically, the present disclosure teaches an apparatus for connecting structural members together comprising, in combination (1) a male member further comprising at least one inward male face and a male protuberance having a top and a bottom, wherein the male protuberance further comprises at least an outward male face and at least one male side face defined by an outward male edge, an inward male edge, a first male edge, and a second male edge, wherein the at least one male side face is inclined inwardly from the outward male edge to the inward male edge; and (2) a female member further comprising at least an outward female face, an inward female face, and a female notch having a top and a bottom, wherein the female notch comprises an open cavity between the outward female face and the inward female face, and is bordered by at least one female side face, wherein each female side face is defined by an outward female edge, an inward female edge, a first female edge, and a second female edge, wherein the at least one female side is inclined outwardly from the inner female edge to the outward female edge, and wherein the female member is adapted to receive the male member within the female notch, wherein receipt of the male protuberance within the female notch engages the male protuberance such that the at least one male side face and the at least one female side face interconnect and the inward male face and the inward female face interconnect, wherein both interconnection of the at least one male side face and the at least one female side face and interconnection of the male inward face and the female outward face carries a load.

Another novel element disclosed herein is a cup-like member comprising at least one female member, wherein each female member comprises, in combination, at least an outward female face, an inward female face, and a female notch having a top and a bottom, wherein the female notch comprises an open cavity between the outward female face and the inward female face, and is bordered by at least one female side face, where each female side face is defined by an outward female edge, an inward female edge, a first female edge, and a second female edge, wherein the at least one female side is inclined outwardly from the inner female edge to the outward female edge.

Also disclosed is a novel method for connecting structural members comprising the step, in combination, of providing a male member and a female member, wherein interconnection of the male member and female member carries load, wherein load is carried by the articulation of at least one male side face and at least one female side face and the articulation of male inward face and female inward face.

More specifically, disclosed is a method for erecting the supporting members of a structure comprising the steps of providing (1) a male member further comprising at least one inward male face, and a male protuberance having a top and bottom, wherein the male protuberance further comprises at least an outward male face and at least one male side face defined by a first male edge, a second male edge, an outward male edge, and an inward male edge, wherein the at least one male side is inclined inwardly from the outward male edge to the inward male edge; and (2) providing a female member further comprising at least an outward female face, an inward female face, and a female notch having a top and a bottom, wherein the female notch comprises an open cavity between the outward female face and the inward female face, at least one female side face, where each female side face is defined by an outward female edge, an inward female edge, a first female edge, and a second female edge, wherein the at least one female side is inclined outwardly from the inner female edge to the outward female edge; and (3) using the male member and the female member to connect two structural members together.

### DRAWINGS

The above-mentioned features and objects of the present disclosure will become more apparent with reference to the following description taken in conjunction with the accompanying drawings wherein like reference numerals denote like elements and in which:

FIG. 1 is a pictorial representation of an embodiment of the present disclosure, including the additional features of a cup-like member and a capping member.

FIG. 2 is a front view of an embodiment of a male member of the present disclosure.

FIG. 3 is a side view of an embodiment of a male member of the present disclosure connected to a nonessential support member via a connecting appendage affixed to nonessential member.

FIG. 4 is a perspective view of an embodiment of a male member of the present disclosure.

FIG. 5 is a top view of an embodiment of a male member of the present disclosure connected to a nonessential support member via a connecting appendage affixed to nonessential member.

FIG. 6 is a front view of an embodiment of female member.

FIG. 7 is a rear view of an embodiment of female member.

FIG. 8 is an exploded view of an embodiment of a male member and a female member demonstrating the proper configuration for engagement and interconnection from the perspective of the outward face of the female member.

FIG. 9 is an exploded view of an embodiment of a male member and a female member demonstrating the proper configuration for engagement and interconnection from the perspective of the inward face of the female member.

FIG. 10 is a top view of an embodiment of cup-like member comprised by four female members, one per side.

FIG. 11 is an exploded view of an embodiment of a male member engaging and interconnecting with one of four female members on a cup-like member and capped with a capping member from the perspective of the outward face of the female member being engaged and interconnected.

FIG. 12 is an exploded view of an embodiment of a male member engaging and interconnecting with one of four female members on a cup-like member from the perspective of the inward face of the female member being engaged and interconnected.

FIG. 13 is an exploded perspective view of an embodiment of a male member engaging and interconnecting with a female member comprising one of four female members on a cup-like member and showing the articulation of male side faces with female side faces.

FIG. 14 is a pictorial view of an embodiment of an interconnected male member and female member on a cup-like member.

FIG. 15 is a pictorial view of an embodiment of two sets of interconnected male member and female member on a cup-like member.

FIG. 16 is an exploded view of an embodiment of two sets of interconnected male member and female member on a cup-like member with a capping member.

FIG. 17 is an exploded view of an embodiment of four sets of interconnected male member and female member on a cup-like member with a capping member.

FIG. 18 is a pictorial view of an embodiment of four sets of interconnected male member and female member on a cup-like member with a capping member.

FIG. 19 is a pictorial view of an embodiment of structure where the structural connection mechanism is the present disclosure.

FIG. 20 is a pictorial view of an embodiment of a worker installing a beam onto a post using the apparatus and method taught by the present disclosure.

### DETAILED DESCRIPTION

Definitions

The term “interconnection” shall indicate a state of the present disclosure where the elements are in a load bearing configuration.

The term “engage” shall denote the process of interconnecting elements of the present disclosure

The term “inward” is a directional indicator denoting elements oriented towards the center of an interconnected present disclosure.

The term “outward” is a directional indicator denoting elements oriented towards the outside of an interconnected present disclosure.

The term “nonessential member” refers to any member connected to male or female member that is not an essential feature of the present disclosure and may include, for example, posts, beams, cross-supports, foundation elements, or other structural members.

“Height” of an element shall be measured along the line substantially parallel to the medial plane of the element.

### DETAILED DESCRIPTION OF THE ELEMENTS

The present disclosure relates to devices and methods for construction enterprises and support structures. In particular, the present disclosure relates to connectors for use with structural members in buildings and other implements requiring a structural framework.

In the aftermath of the many recent natural disasters, the present disclosure is well adapted for use as a connector in quickly-built temporary, semi-permanent, or permanent structures for those displaced as a result of these natural phenomena. Structures can be built using the present disclosure by unskilled labor because the present disclosure is self-aligning. Consequently, volunteer laborers, for example, may contribute to the building of structures using the present disclosure without the need for additional training, while still connecting structural pieces in correct alignment for optimal load bearing. This improves the quality of and speed in which the structure is built in the wake of natural disasters and eliminates error and complexity making traditional apparatuses and methods unsuitable for unskilled labor.

The present disclosure is also well adapted for use in permanent structures. In addition to the speed with which a structure may be built, the present disclosure also imbues structures with additional advantages. As will be understood by those skilled in the art, the apparatus disclosed herein may be used, in an embodiment, for beams connected to posts. Such an apparatus resists deflection by controlling and resisting the moment arm of the beam, supplies the necessary forces to hold the beam in place on the post, and effectively transfers the load carried by the beam to the post and thence to the foundation or ground.

Moreover, the components of the present disclosure are self-aligning. When the connection between the elements is made as described herein, the pieces come together in a single orientation, which precisely aligns the nonessential members connected with the apparatus. Thus, all joints connected are accurate and consistent. Accuracy and consistency reduces variability in the aggregate structure, thereby eliminating or reducing “play” in the structure that would otherwise weaken it.

The net result reduces the need for diagonal braces for support against lateral forces on a structure, such as wind or seismic activity. Additionally, because the present disclosure serves to resist the moment of beams more effectively than traditional connection methods, there is less need for closely spaced posts, which saves materials and money.

Consequently, the present disclosure is appropriate for all manner of support structures. For example, in addition to permanent housing, the present disclosure is well adapted in the construction of tents or other non-permanent installations in the field, for example for use by the military. These structures are quickly built, but more durable than traditional connectors because of the precise alignment and strength of the connection. Thus, the support framework built with the present disclosure is just as durable or more durable than traditional means of connecting the supporting members. Additionally, the present disclosure may be used for other purposes requiring a structural framework. The present disclosure is useful for structures common in tradeshows, such as large tents, pavilions, convention centers, and stages. Moreover, the present disclosure is useful in other implements requiring a supporting structure such as bridges and the frames of planes, boats, and cars. Indeed, use of the present disclosure is appropriate for all quickly built structures where durability and strength of the structural framework is desired. As such, the present disclosure is not limited to quickly built temporary or semi-permanent structures.

The present disclosure constitutes a novel enhanced structural connector. The connector may be used without bolts, pins, screws, nails, welds, or other means to ensure integrity of the connection. Nevertheless, the connection comprises a strong interface between posts and beams, beams and beams, posts and posts, and other structural connections according to an embodiment. Moreover, because the present disclosure does not require bolts, screws, pins, nails, welds, or other means to ensure integrity of the connection, the present disclosure requires no expertise to operate. Indeed, it can be used by unskilled laborers, such as volunteers. However, the present disclosure may be used in building permanent structures, temporary structures, or other structural frameworks for any application requiring a structural framework. Thus, the present disclosure expressly contemplates use as a general purpose connector, useful, but not limited to, structural connections in buildings.

In embodiments of the present disclosure, at least one male side face 106 engages and interconnects with at least one female side face 206. The combination of the both interconnection of at least one male side face 106 with at least one female side face 206 and the interconnection of at least a portion of at least one male inward face 104 with inward female face 202 controls and reduces rotation horizontally and vertically as previously described without the need for additional load carrying elements, such as crossbeams or closely spaced structural supports. Indeed, interconnection of male member 100 and female member 200 provides resistant force to the moment arm of one connected nonessential member to another.

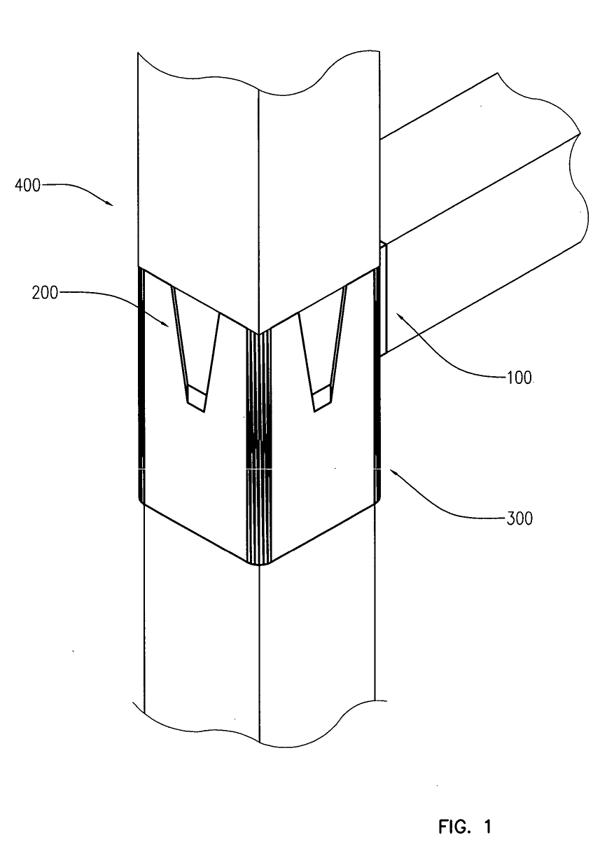

According to an embodiment represented in FIG. 1, the present disclosure comprises male member 100 and female member 200, which are interconnected with each other. Interconnection of male member 100 and female member 200 does not require bolts, screws, pins, nails, welds, or other means of ensuring male member 100 and female member 200 remain fixed relative to each other. Nevertheless, embodiments of the present disclosure may use bolts, screws, pins, nails, welds, or other means of ensuring male member 100 and female member 200 remain fixed relative to each other, although one skilled in the art would recognize them to be superfluous, useful as a secondary safety or securing mechanism. In embodiments, cup-like member 300, comprised by a plurality of female members 200, and capping member 400 allow for multiple connections between sets of male member 100 and female member 200 and continuation of the structural elements upon which cup-like member 300 resides.

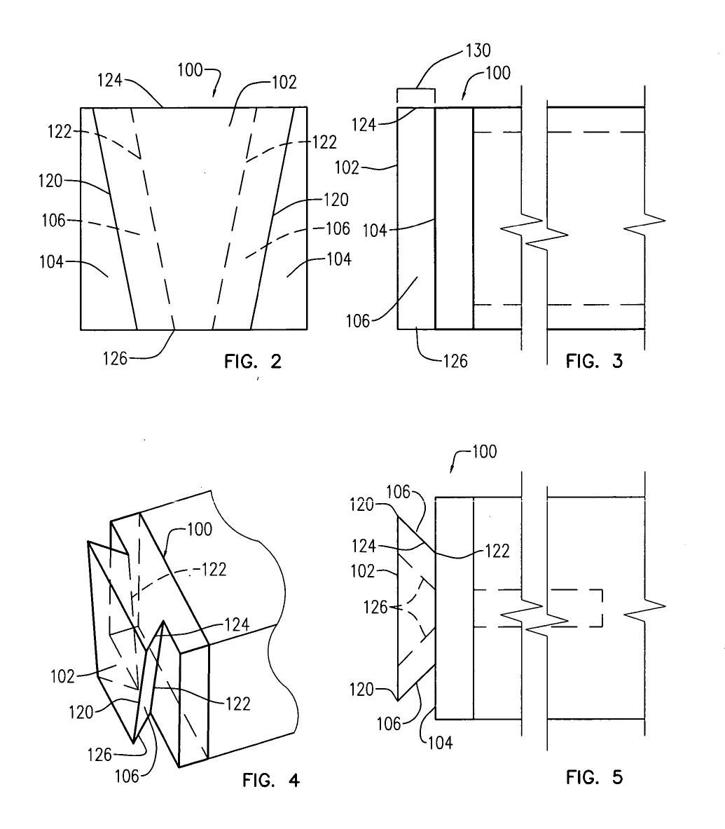

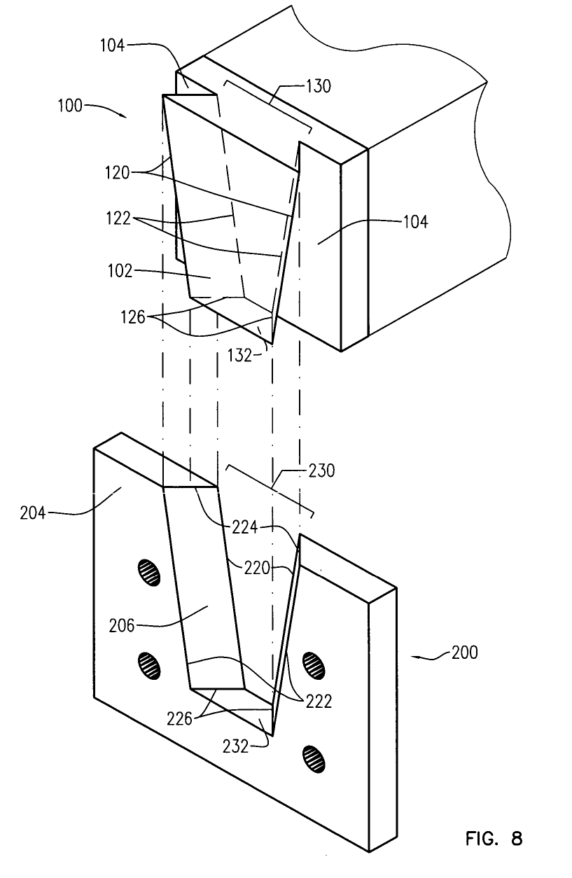

According to FIG. 2 and an embodiment, male member 100 is comprised of outward male face 102, at least one inward male face 104, and at least one male side face 106. When interconnected, inward male face articulates with outward female face 204 as part of the load carrying system to control and resist rotation in the connected nonessential members. In an embodiment, outward male face 102 does not articulate with a corresponding female element in a load bearing capacity. However, alternate embodiments may utilize outward male face 102, in combination with inward male face 104 and each male side face 106, in a load bearing capacity. For example, if capping member 400 (FIG. 1) is used in conjunction with cup-like member 300, outward male face 102 may articulate with a surface of capping member 400 in a load bearing capacity. Moreover, horizontal surfaces of the male member 100 may articulate with horizontal surfaces in female member 200 to carry load in conjunction with the other elements of male member 100 and female member 200. For example, male bottom surface 132 (FIG. 8) may articulate with female bottom surface 232 (FIG. 8) to resist the force of gravity, as would be known by those skilled in the art.

Male member 100 may be made of wood, metal, composite materials, other materials common in the art, or a combination thereof. The present disclosure also contemplates that male member 100 may be made from other materials commonly used as building materials or building materials that will be used in the future.

Outward male face 102 and each male side face 106 comprise male protuberance 130, which protrudes from the surface of inward male face 104, shown in FIG. 3. Male protuberance 130 rests on inward male face 104, and may divide inward male face 104 into multiple inward male faces 104 by covering inward male face 104 from edge to edge, as exemplified in FIG. 2. Thus, as demonstrated in FIG. 2 inward male face 104 is divided into two inward male faces 104, both of which carry load when interconnected with female inward face 202.

Referring again to the embodiment shown in FIG. 2, male protuberance 130 has a top and a bottom. Male protuberance 130 narrows in width as a function of height, such that the length of the shortest horizontal line between outward male edges 120 at any point higher than the bottom point in the height of outward male edges 120 is greater than the length of the shortest horizontal line between outward male edges 120 measured at the bottom of male protuberance 130. Nevertheless, the present disclosure also contemplates an embodiment comprising male protuberance 130 that does not narrow in width as a function of height or that does not narrow in width as a function of height throughout a portion of the height of male protuberance 130.

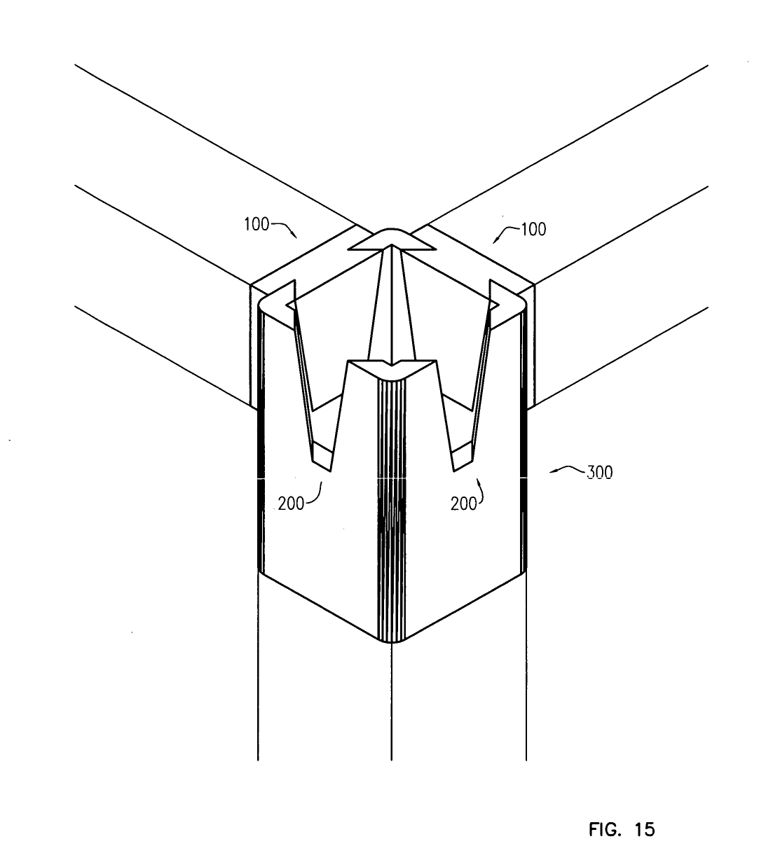

According to an embodiment represented by FIG. 4, male side face 106 is comprised of a region bounded by outward male edge 120, inward male edge 122, top male edge 124, and bottom male edge 126. Male side face 106 articulates with female side face 206 when male member 100 is interconnected with female member 200. When interconnected, male side face 106 and female side face 206 carry load that controls and resists rotation in the connected nonessential members horizontally and vertically. In an embodiment, male side face 106 may be comprised of additional edges, which divide male side face 106 a subset of multiple faces comprising male side face 106. However, one skilled in the art will recognize that, for the purposes of the present disclosure, male side face 106 comprises all load bearing surfaces of male protuberance 130 that are defined by outward male edge 120, inward male edge 122, top male edge 124, and bottom male edge 126. As previously discussed, an embodiment may further comprise male bottom surface 132 (FIG. 13) that spans a portion of male protuberance 130 at the bottom between male side faces 106 on the horizontal plane. Male bottom surface 132, acting in conjunction with the other load bearing surfaces, tends to resist the force of gravity in the connected members.

Male member 100 may be connected to a nonessential member, a beam for example, by bolts, pins, screws, nails, welds, adhesives, or other means of affixing connectors to nonessential members common in the art. The present disclosure also contemplates creating male member 100 as an integral component of the nonessential member. In such an embodiment, male member 100 does not require connection of any sort.

For example, as embodied in FIG. 3 and FIG. 5, male member 100 connects to the nonessential member by a post. The post may be connected within a cavity of nonessential member with adhesives or with bolts, screws, nails, or pins driven longitudinally through the nonessential member and the post, as would be obvious to an artisan.

As demonstrated in FIG. 5, each male side face 106 inclines inwardly from outward male edge 120 to inward male edge 122. Consequently, the length of the shortest horizontal line between each point between outward male edge 120 to outward male edge 120 spanning male protuberance 130 is greater than the length of the shortest horizontal line at the same horizontal point measured from inward male edge 122 to inward male edge 122 spanning male protuberance 130. The incline of male side face 106 resembles a dovetail connector and operates similarly by preventing disengagement of male member 100 from female member 200 once interconnected in any direction in the transverse plane, as would be known to a person skilled in the art.

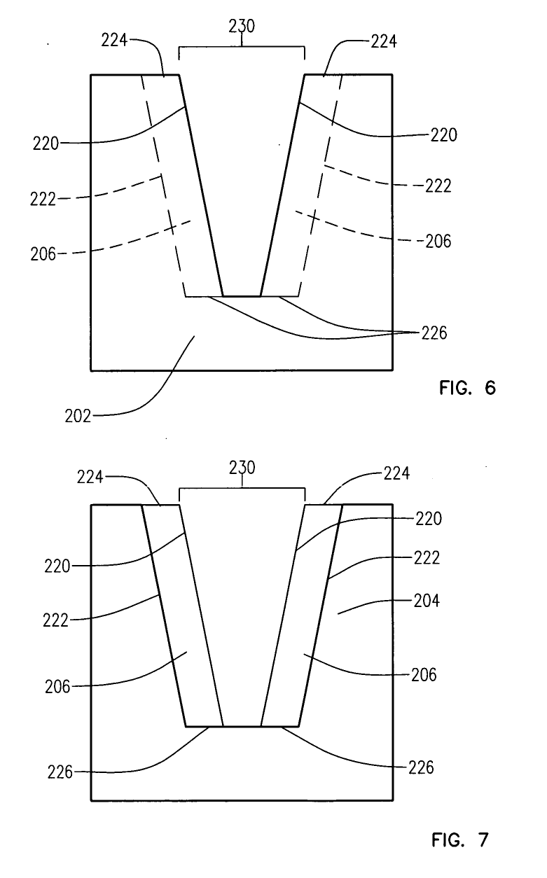

Referring to an embodiment represented by FIG. 6, female member 200 comprises inward female face 202, outward female face 204 (shown in FIG. 7), and at least one female side face 206. A cavity bordered by each female side face 206 define female notch 230 in female member 200. Inward female face 202 is a load carrying surface. It articulates with male inward face 104 to carry load when male member 100 and female member 200 are interconnected, as previously described.

Female member 200 may be made of wood, metal, composite materials, other materials common in the art, or a combination thereof. The present disclosure also contemplates that female member 200 may be made from other materials commonly used as building materials or building materials that will be used in the future.

Referring to the embodiment represented in FIG. 7, each female side face 206 is comprised of inward female edge 220, outward female edge 222, top female edge 224, and bottom female edge 226. Female side face 206 articulates with male side face 106 when male member 100 is interconnected with female member 200 and carries load in combination with the load carried by the articulation of male inward face 204 and female inward face 202. Like male side face, female side face 206 may be comprised of additional edges, which divide female side face 206 into a subset of multiple faces comprising female side face 206. However, one skilled in the art will recognize that, for the purposes of the present disclosure, female side face 206 comprises all load bearing surfaces comprising the side elements of female notch 230 defined by the surfaces bounded by inward female edge 220, outward female edge 222, top female edge 224, and bottom female edge 226. As previously discussed, an embodiment may further comprise female bottom surface 232 that spans a portion of female notch 230 between female side faces 206 on the horizontal plane. Female bottom surface 232, acting in conjunction with the other load bearing surfaces, tends to resist the force of gravity in the connected members.

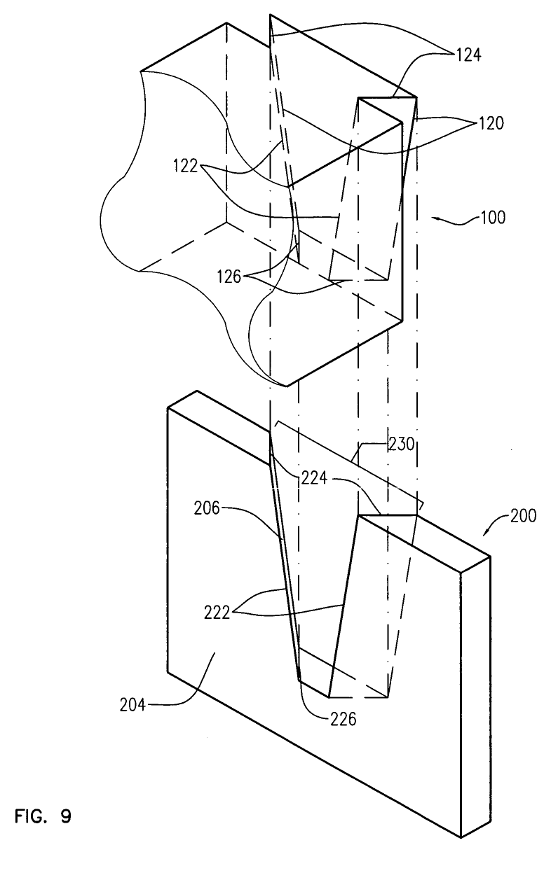

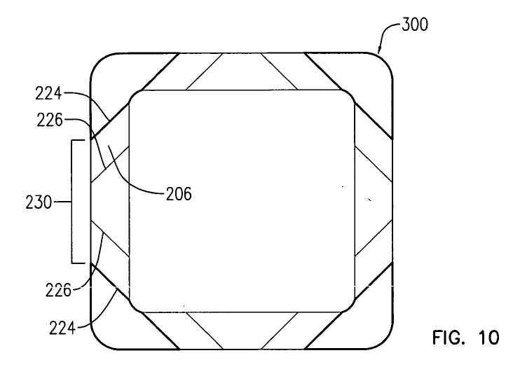

As shown in the embodiment represented in FIG. 8, each female side face 206 inclines outwardly from inward female edge 220 to outward female edge 222. Consequently, the length of the shortest horizontal line between each point along outward female edge 222 to outward female edge 222 spanning female notch 230 is greater than the length of the shortest horizontal line between each point of inward female edge 220 to inward female edge 220 spanning female notch 230. In conjunction with male protuberance 130, the incline of female notch 230 forms a dovetail-like joint, operating similarly to prevent lateral movement in all directions in the transverse plane once male member 100 and female member 200 are interconnected. FIG. 9 demonstrates the same essential features as FIG. 8 from the opposite point of view.

Referring again to an embodiment represented in FIG. 7, outward female face 204 comprises outward surface of female member 200. Outward female face 204 is not a load carrying element of the present disclosure. Unlike outward male face 102, however, which can be used in some embodiments to carry load when additional elements, such as capping member 400, are used, articulation of outward female face 204 with, for example, capping member 400 provides no additional load carrying capacity when interconnected with male member 100.

Nevertheless, in embodiments, outward female face 204 may be a connection point with nonessential members. The surface of outward female face 204 contacts the nonessential member and connects to it with bolts, screws, pins, nails, welds, adhesives, or other means of connecting female member 200 to a nonessential member common in the art. For example, the embodiment of FIG. 8 demonstrates the connection of female member 200 to a nonessential member with bolts, screws, or nails. Similarly, female member 200 may be connected with a post element similar to the method used to connect male member 100 to nonessential member in FIG. 5 as previously described. As demonstrated by an embodiment represented in FIG. 10 using cup-like member 300 or an equivalent, female member 200 may function as part of the present disclosure in a load bearing capacity and be connected to a nonessential member only indirectly.

Referring to FIG. 8, female notch 230 is substantially the same shape as male protuberance 130. Thus, each male side face 106 engages and interconnects with at least one female side face 206, inward male face 104 engages and interconnects with inward female face 202, male bottom surface 132 engages and interconnects with female bottom surface 232, and outward male face 102 and outward female face 204 are flush when male member 100 and female member 200 are interconnected. However, embodiments are contemplated where the outward male face 102 and outward female face 204 are not flush with each other without affecting the utility of the present disclosure.

Referring to FIG. 10, an embodiment comprises cup-like member 300. Cup-like member 300 is comprised of a plurality of female members 200. In addition to the plurality of female members 200 in an embodiment, cup-like member 300 also comprises a cavity bordered by the plurality of female members 200 on the sides and a nonessential member on the bottom. The top of the cavity is open to receive capping member 400 if present and if cup-like member 300 occurs mid-nonessential member. In an alternate embodiment, a suitable material fills the cavity of cup-like member 300. This embodiment is likely to arise when cup-like member 300 is placed at the top of a nonessential member. In such situations, filling material can be the same material from which cup-like member 300 is made. Cup-like member 300 can also be fitted over a narrowed area at the top of the nonessential member such that the filling material is the narrowed portion of the nonessential member.

Cup-like member 300 provides a single node for multiple connections. In an embodiment, cup-like member 300 is a node where multiple beams fitted with male members 100 connect to a post fitted with cup-like member 300. Once a beam is connected to a male member 100, it can be interconnected with female member 200 in cup-like member 300.

Cup-like member 300 may be made of wood, metal, composite materials, other materials common in the art, or a combination thereof. The present disclosure also contemplates cup-like member 300 may be made of other materials commonly used as building materials or building materials that will be used in the future.

In an embodiment, cup-like member 300 rests on a nonessential member and may be used to connect other nonessential members (see FIG. 15, for example). As indicated previously, cup-like member 300 can occur at the top of a nonessential member or mid-nonessential member. If cup-like member 300 occurs at a mid-nonessential member location, capping member 400 may be installed. Capping member 400 comprises the portion of nonessential member that would exist above cup-like member 300 in cup-like member's 300 absence. It is narrowed at an end to fit within the cavity of cup-like member 300. It is placed in cavity cup-like member 300 once interconnection of all desired sets of male member 100 and female member 200 are accomplished. The surfaces of capping member 400 inserted into cup-like member 300 may optionally be used as additional load carrying surfaces in an embodiment previously described by articulating with outward male face 102.

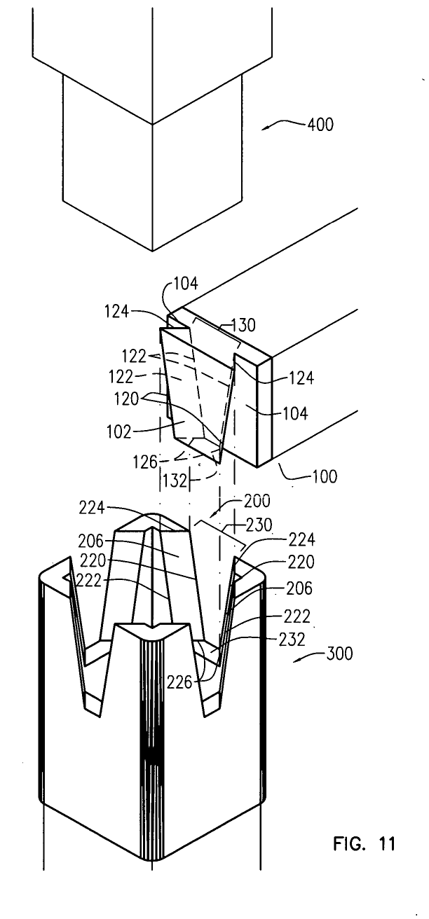

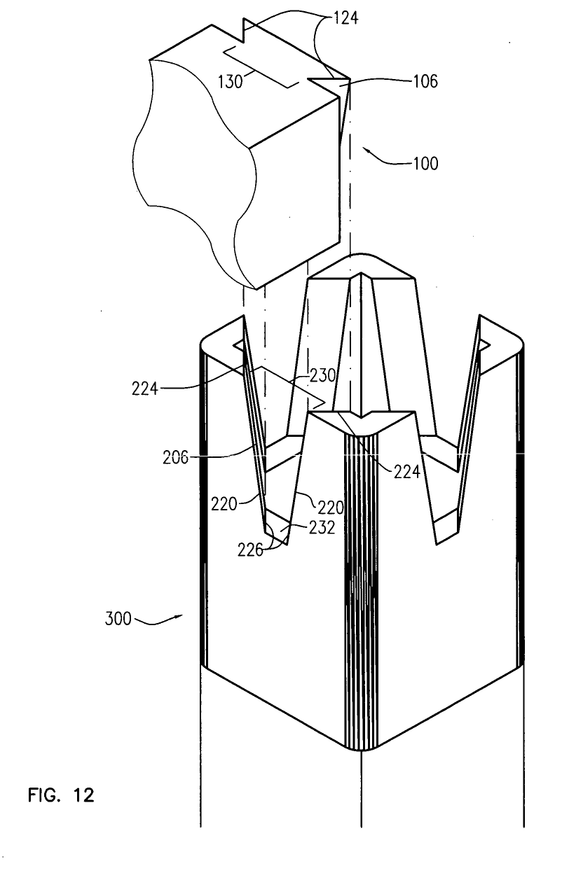

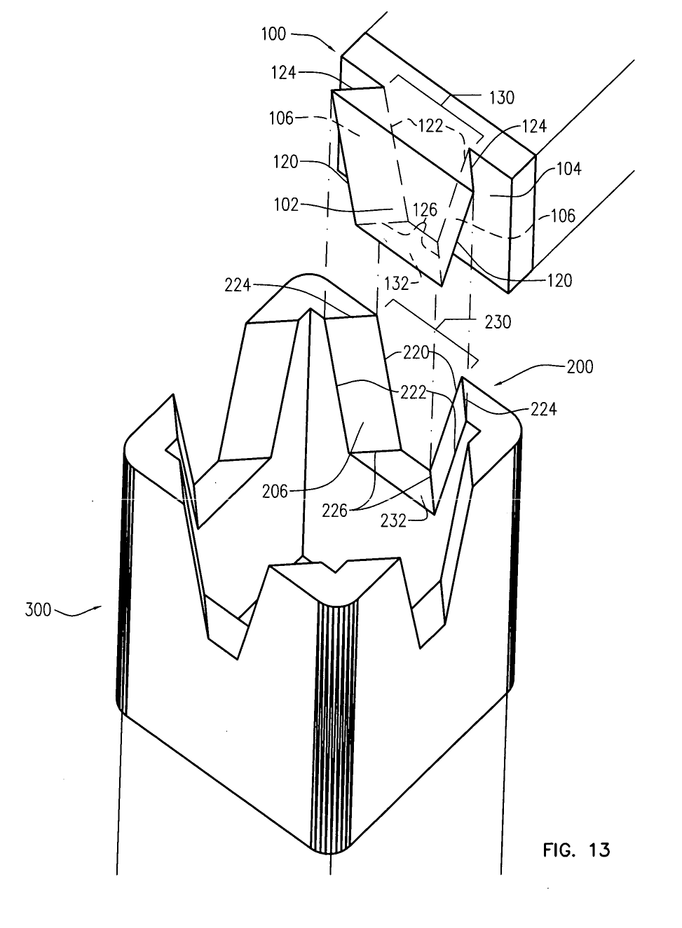

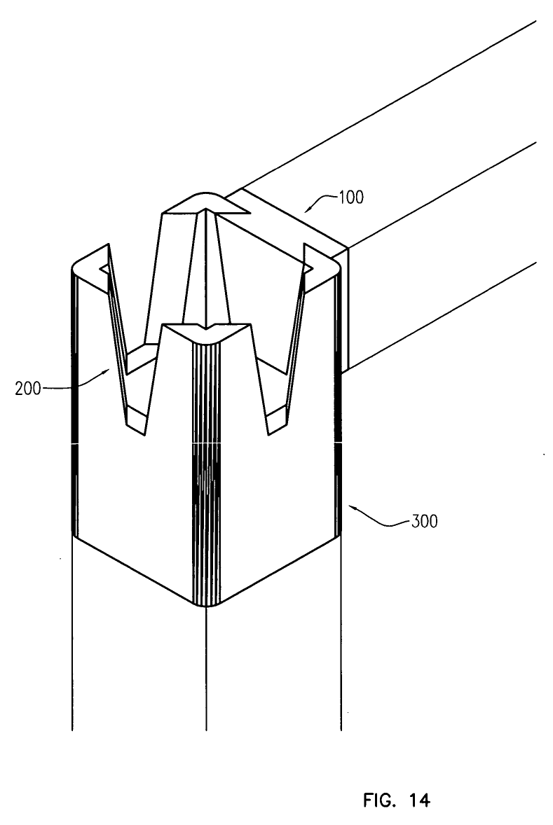

As demonstrated in an embodiment represented in FIG. 11, the process of connecting male member 100 to female member 200 is relatively simple. Operation of the present disclosure first requires alignment of male member 100 with female member 200. The shape of female notch 230 viewed in cross-sections of the transverse plane is roughly trapezoidal, where the long parallel side of the trapezoid is the horizontal line spanning female notch 230 from outward female edge 222 to outward female edge 222 (best seen in FIG. 13), and the short parallel side of the trapezoid is the horizontal line spanning female notch 230 from inward female edge 220 to inward female edge 220 and the trapezoid's sides comprised by the lines from outward female edge 220 to inward female edge 222. The shape of male protuberance 130 in the embodiment demonstrated in FIG. 13 is also roughly trapezoidal as viewed in cross-sections of the transverse plane, where the long parallel side is comprised of the horizontal length of outward male face 102 and the short parallel side is the horizontal line spanning male protuberance 130 from inward male edge 122 to inward male edge 122, and the trapezoid's sides are comprised by the lines from outward male edge 120 to inward male edge 122.

Once the trapezoidal male protuberance 130 and trapezoidal female notch 230 are directed in the same orientation, as demonstrated FIG. 9, they may be engaged and interconnected. Male member 100 and female member 200 may only engage in an orientation where trapezoidal male protuberance 130 and trapezoidal female notch 230 are aligned in the transverse plane. Moreover, as previously discussed in an embodiment, male protuberance 130 narrows in width from top to bottom and female notch 230 also narrows in width from top to bottom. Consequently, in addition to the necessity to align male protuberance 130 with female notch 230 in the transverse plane male member 100 may engage and interconnect with female member 200 in a single orientation in the coronal plane, effectively allowing only a single direction of movement of male member 100 and female member 200 relative to each other once interconnected.

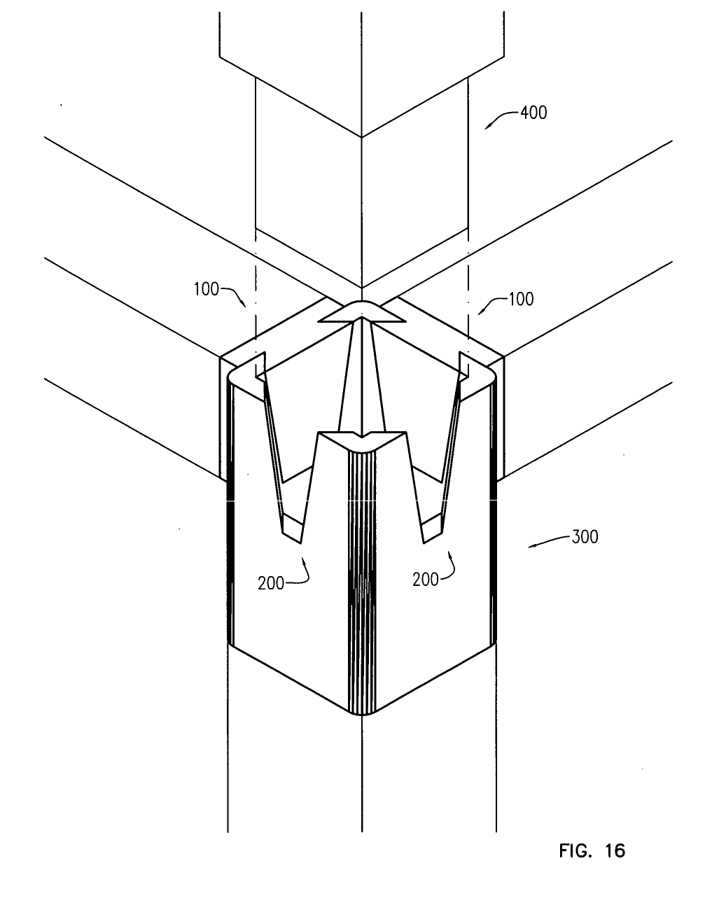

In an embodiment demonstrated in FIG. 13, once male member 100 is aligned with female member 200, they are engaged by placing male protuberance 130 above female notch 230 and placing male protuberance 130 into female notch 230. Placement is accomplished by moving male member 100 such that each male side face 106 engages and interconnects with at least one female side face 106 and such that each inward male face 104 engages and interconnects with inward female face 202. In an embodiment, male bottom face 132 will engage and interconnect with female bottom face 232 when male member 100 is properly engaged and interconnected with female member 200. When the load bearing surfaces have articulated, male member 100 is interconnected with female member 200. Once interconnected, male member 100 and female member 200 will be in the confirmation depicted in FIG. 14.

Once interconnected, movement in all directions in the transverse plane is prevented by the opposite orientation of the wide and narrow elements of interconnected male member 100 and female member 200. The outward elements of both male member 100 and female member 200 are wide. The inward elements of male member 100 and female member 200 are narrow. Consequently, movement in all directions in the transverse plane would require outward elements of male member 100 and female member 200 to move through the inward elements of male member 100 and female member 200. However, because the outward elements are wider than the inward elements, such movement is prevented.

Once interconnected, the same vertical movement used to place male member 100 into female member 200 is possible, if the correct force is applied. In an embodiment, use of a bolt, pin, screw, nail, weld, or other means to prevent vertical movement may be employed. Consequently, once interconnected, male member 100 and female member 200 are “locked” relative to each by use of implements common in the art that serve to restrict movement unidirectionally. Although not necessary to accomplish the objectives taught by the present disclosure, they may be used as secondary safety or securing features.

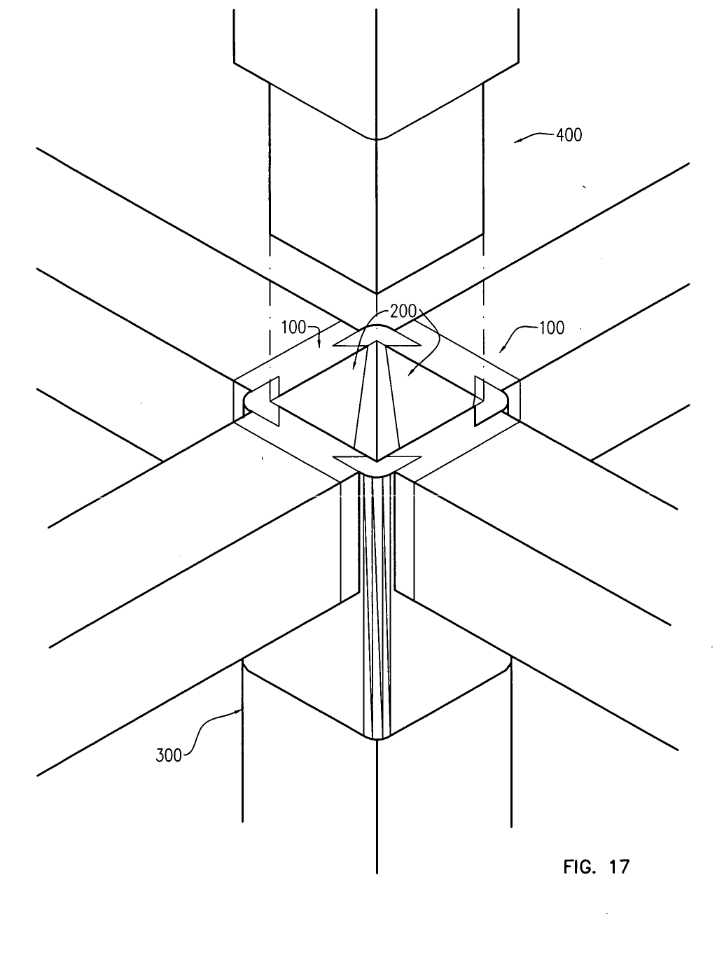

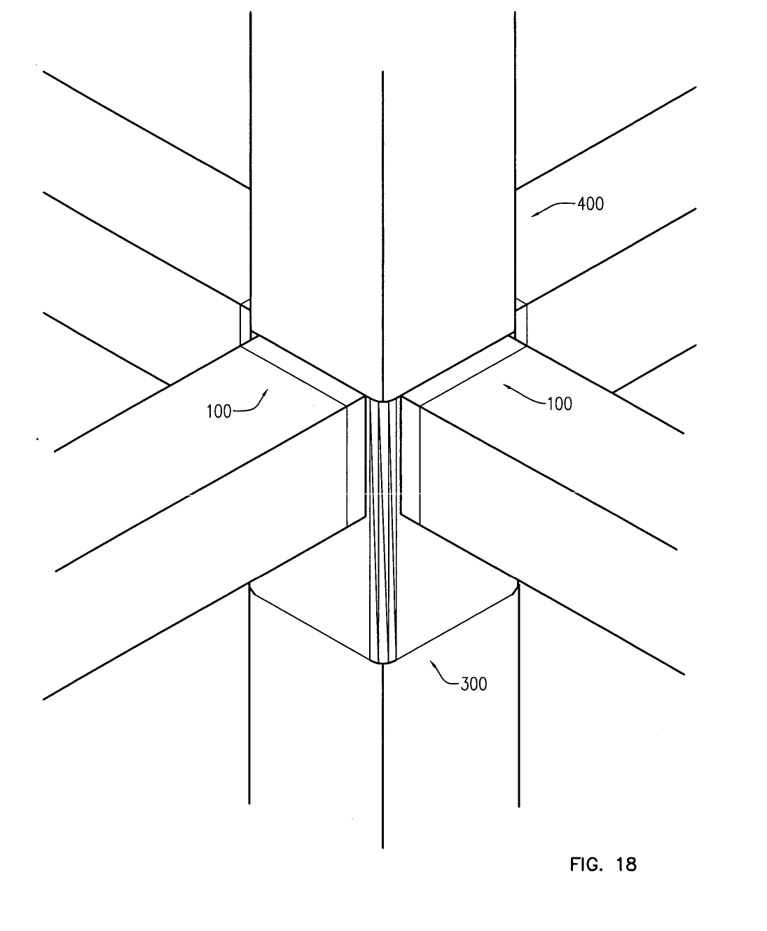

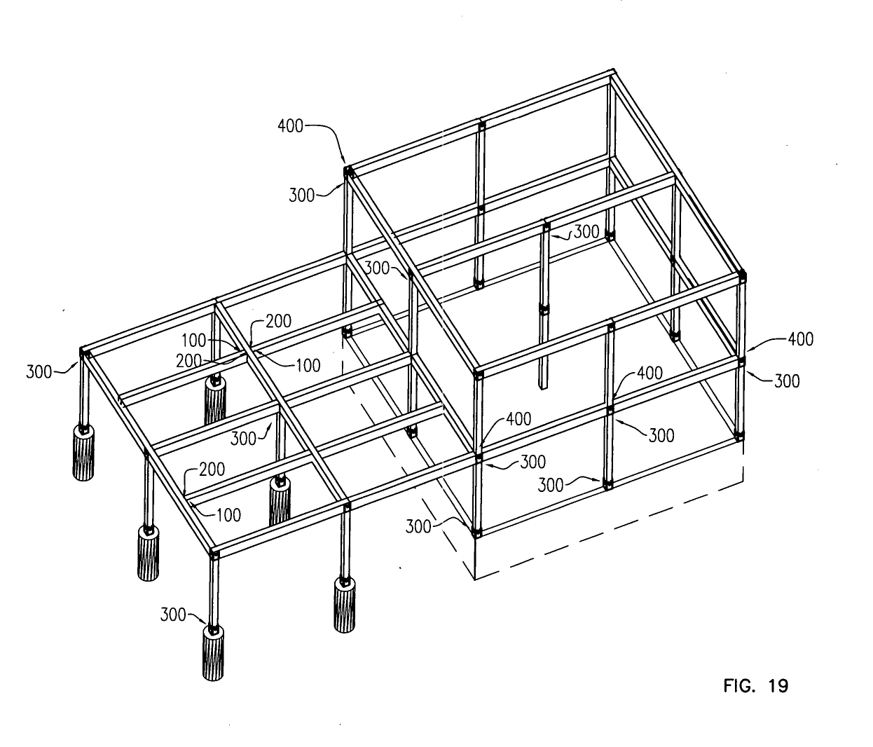

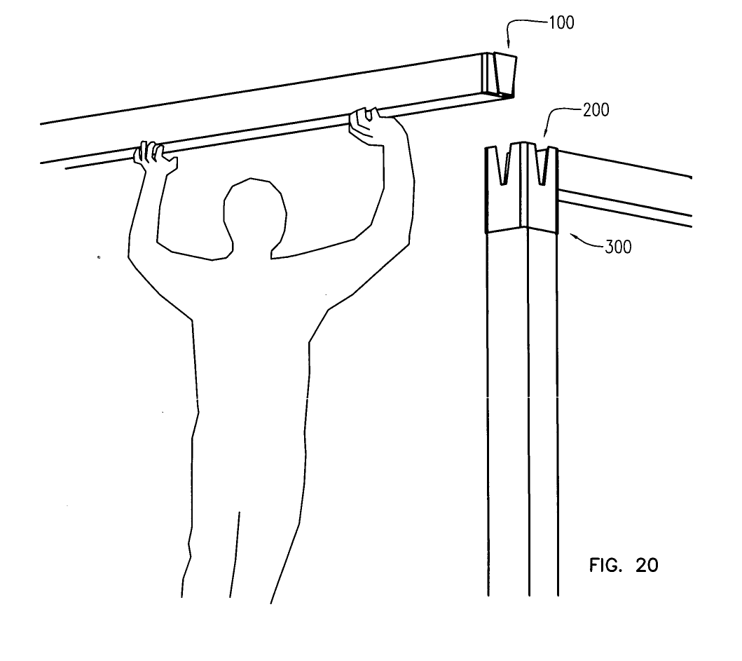

The method of interconnection of male member 100 and female member 200 comprising part of cup-like member 300 is shown in FIG. 14. Cup-like member 300 comprises a plurality of female members 200. Thus, multiple male members 100 connected to nonessential members may be connected to a single cup-like member 300 by repeating the interconnection process previously described for additional male members 100 and female members 200 as shown in FIG. 15. Once all desired male member 100 and female member 200 interconnections are accomplished according to the process previously described, capping member 400 may be placed into position as depicted in the exemplary embodiment represented in FIG. 16. The process may be repeated for other configurations comprising additional sets of male members 100 interconnected with female members 200 as depicted in FIG. 17 in an uninterconnnected configuration and FIG. 18 in an interconnected configuration.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. An apparatus for connecting structural members together comprising, in combination a male member and a female member;
wherein interconnection of the male member and the female member carries load, wherein load is carried by the articulation of at least one male side face and at least one female side face and the articulation of an inward male face and an inward female face.

2. The apparatus of claim 1, wherein the at least one male side face comprises two or more surfaces.

3. The apparatus of claim 1, wherein the at least one female side face comprises two or more surfaces.

4. The apparatus of claim 1, wherein the number of male side faces and the number of female side faces are equal and wherein each male side face engages and interconnects with a corresponding female side face of about the same surface area when a female notch receives a male protuberance.

5. The apparatus of claim 1 wherein a horizontal width of a male protuberance narrows from the top to the bottom and wherein a horizontal width of a female notch narrows from a top to a bottom.

6. The apparatus of claim 1, wherein a surface of the inward male face and a surface of the inward female face are one of cylindrical, spherical, flat, and combinations thereof.

7. The apparatus of claim 1, wherein each structural member is one of the group of posts, beams, cross-supports, and foundation elements.

8. The apparatus of claim 7, wherein the apparatus connects one of: a beam to a post, a beam to a beam, a cross-support to a post, a cross-support to a beam, a cross-support to a foundation element, and a post to a foundation element.

9. The apparatus of claim 1, wherein the apparatus is made from one of wood, metal, composite materials, and combinations thereof.

10. The apparatus of claim 1, wherein the apparatus a first structural member and a second structural member are aligned when in an interconnected state.

11. An apparatus for connecting structural members together comprising, in combination:
a male member further comprising:
a) at least one inward male face; and
b) a male protuberance having a top and a bottom, wherein the male protuberance further comprises at least:
i) an outward male face; and
ii) at least one male side face defined by:
1) an outward male edge;
2) an inward male edge;
3) a first male edge; and
4) a second male edge;
wherein the at least one male side face is inclined inwardly from the outward male edge to the inward male edge;
a female member further comprising at least:
a) an outward female face;
b) an inward female face; and
c) a female notch having a top and a bottom, wherein the female notch comprises an open cavity between the outward female face and the inward female face, and is bordered by at least one female side face, wherein each female side face is defined by:
i) an outward female edge;
ii) an inward female edge;
iii) a first female edge; and
iv) a second female edge;
wherein the at least one female side is inclined outwardly from the inner female edge to the outward female edge; and
wherein the female member is adapted to receive the male member within the female notch, wherein receipt of the male protuberance within the female notch engages the male protuberance such that the at least one male side face and the at least one female side face interconnect and the inward male face and the inward female face interconnect, wherein both interconnection of the at least one male side face and the at least one female side face and interconnection of the male inward face and the female outward face carries a load.

12. The apparatus of claim 11 wherein the load carried is at least one of the group of forces consisting of: resistance to horizontal rotation, resistance to vertical rotation, resistance to the force of gravity, or transference of force from a first support member into a second support member.

13. The apparatus of claim 11 wherein the at least one male side face comprises two or more surfaces.

14. The apparatus of claim 11 wherein the at least one female side face comprises two or more surfaces.

15. The apparatus of claim 11 wherein the number of male side faces and the number of female side faces are equal and wherein each male side face engages and interconnects with a corresponding female side face of about the same surface area when the female notch receives the male protuberance.

16. The apparatus of claim 11 wherein a horizontal width of the male protuberance narrows from the top to the bottom and wherein a horizontal width of the female notch narrows from the top to the bottom.

17. The apparatus of claim 11 wherein a surface of the outward male face and a surface of the inward male face and a surface of the outward female face and a surface of the inward female face are one of cylindrical, spherical, flat, or combinations thereof.

18. The apparatus of claim 11 wherein the first male edge and first female edge correspond to a male top edge and a female top edge respectively and wherein the second male edge and the second female edge correspond to a male bottom edge and a female bottom edge respectively.

19. The apparatus of claim 11 wherein each structural member is one of the group of posts, beams, cross-supports, and foundation elements.

20. The apparatus of claim 19, wherein the apparatus connects one of: a beam to a post, a beam to a beam, a cross-support to a post, a cross-support to a beam, a cross-support to a foundation element, and a post to a foundation element.

21. The apparatus of claim 11, wherein the apparatus is made from one of wood, metal, composite materials, and combinations thereof.

22. The apparatus of claim 11, wherein the apparatus a first structural member and a second structural member are aligned when in an interconnected state.

23. A cup-like member comprising at least one female member, wherein each female member comprises, in combination, at least:
a) an outward female face;
b) an inward female face; and
c) a female notch having a top and a bottom, wherein the female notch comprises an open cavity between the outward female face and the inward female face, and is bordered by at least one female side face, where each female side face is defined by:
i) an outward female edge;
v) an inward female edge;
vi) a first female edge; and
vii) a second female edge;
wherein the at least one female side is inclined outwardly from the inner female edge to the outward female edge.

24. The cup-like member of claim 23 wherein the cup-like member is an element of a structural member.

25. The apparatus of claim 24 wherein each structural member is one of the group consisting of posts, beams, cross-supports, and footings.

26. The apparatus of claim 23, wherein the cup-like member is made from wood, metal, or composite materials.

27. A method for connecting structural members comprising the step, in combination, of providing a male member and a female member;
wherein interconnection of the male member and female member carries load, wherein load is carried by the articulation of at least one male side face and at least one female side face and the articulation of male inward face and female inward face.

28. The method of claim 27 further comprising the step of causing a male protuberance to be received into a female notch, wherein the male member becomes interconnected with the female member.

29. The method of claim 28 wherein receipt of the male protuberance into the female notch causes the structural members to correctly align.

30. A method for erecting the supporting members of a structure comprising the steps of:
providing a male member further comprising at least:
a) at least one inward male face; and
b) a male protuberance having a top and bottom, wherein the male protuberance further comprises at least:
i) an outward male face; and
ii) at least one male side face defined by:
1) an outward male edge;
2) an inward male edge;
3) a first male edge; and
4) a second male edge;
providing a female member further comprising at least:
a) an outward female face;
b) an inward female face; and
c) a female notch having a top and a bottom, wherein the female notch comprises an open cavity between the outward female face and the inward female face, at least one female side face, where each female side face is defined by:
i) an outward female edge;
ii) an inward female edge;
iii) a first female edge; and
iv) a second female edge;
wherein the at least one female side is inclined outwardly from the inner female edge to the outward female edge; and
using the male member and the female member to connect two structural members together.

31. The method of claim 30 further comprising the step of causing the male protuberance to be received into the female notch, wherein the male member becomes interconnected with the female member.

32. The method of claim 31 wherein receipt of the male protuberance into the female notch causes the structural members to correctly align.
